(19) United States
(12) Patent Application Publication
(10) Pub. No.: US 2023/0164711 A1
(43) Pub. Date: May 25, 2023

(54) BANDWIDTH PART ASSIGNMENT IN WIRELESS COMMUNICATION SYSTEMS

(71) Applicant: QUALCOMM Incorporated, San Diego, CA (US)

(72) Inventors: Liangping MA, San Diego, CA (US); Xiao Feng WANG, San Diego, CA (US); Huilin XU, Temecula, CA (US); Dan ZHANG, San Diego, CA (US); Iyab Issam SAKHNINI, San Diego, CA (US); Yiqing CAO, Beijing (CN); Jun MA, San Diego, CA (US); Qiang WU, San Diego, CA (US)

(21) Appl. No.: 17/757,836

(22) PCT Filed: Jan. 14, 2021
(86) PCT No.: PCT/CN2021/071762

§ 371 Date: Jun. 22, 2022

(30) Foreign Application Priority Data
Jan. 16, 2020 (CN) PCT/CN2020/072381

(51) Int. Cl. H04W 56/00; H04W 72/1273; H04W 16/28

(52) U.S. Cl. CPC H04W 56/001; H04W 72/1273; H04W 16/28

(57) ABSTRACT

A method of wireless communication, the method including: receiving a synchronization signal block (SSB) from a first wireless communication device; acquiring information from the SSB, wherein the information from the SSB leads to configuration information for using an initial downlink bandwidth part and an initial uplink bandwidth part; and communicating between the first wireless communication device and a second wireless communication device using the initial downlink bandwidth part and the initial uplink bandwidth part.

### TECHNICAL FIELD

This application relates to wireless communication systems, and more particularly to bandwidth part assignments in a wireless communication network.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the long term evolution (LTE) technology to a next generation new radio (NR) technology, which may be referred to as 5^{th} Generation (5G). For example, NR is designed to provide a lower latency, a higher bandwidth or a higher throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as mmWave bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

NR technology may also make use of a variety of different base station and user equipment technologies to maintain communication at acceptable throughput rates. For instance, some terrestrial base stations may employ beamforming to increase connectivity with user equipment. Furthermore, some NR technology employs satellites to either act as base stations or to assist base stations in reaching user equipment that may not be serviced by a terrestrial resource. In any event, both terrestrial NR and satellite NR may use initial access techniques to assign portions of the spectrum to user equipment. There is a need in the art for more efficient and effective spectrum assignment.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

For example, in an aspect of the disclosure, a method of wireless communication includes receiving a synchronization signal block (SSB) from a first wireless communication device, wherein the SSB is received via a first beam of a plurality of beams from the first wireless communication device; based on the SSB, acquiring configuration information specific to the first beam for using an initial downlink bandwidth part and an initial uplink bandwidth part; and communicating between the first wireless communication device and a second wireless communication device on the first beam using the initial downlink bandwidth part and the initial uplink bandwidth part.

In an additional aspect of the disclosure, a method includes transmitting a synchronization signal block (SSB) from a first wireless communication device, wherein the SSB is transmitted via a first beam of a plurality of beams from the first wireless communication device, wherein information in the SSB leads to configuration information specific to the first beam for using an initial downlink bandwidth part and an initial uplink bandwidth part, and communicating between the first wireless communication device and a second wireless communication device on the first beam using the initial downlink bandwidth part and the initial uplink bandwidth part.

In an additional aspect of the disclosure, an apparatus includes a transceiver configured to: receive a synchronization signal block (SSB) from a first wireless communication device via a first beam of a plurality of beams from the first wireless communication device; and a processor configured to: acquire configuration information specific to the first beam for using an initial downlink bandwidth part and an initial uplink bandwidth part, based on the SSB; and negotiate with the first wireless communication device on the first beam using the initial downlink bandwidth part and the initial uplink bandwidth part.

In another aspect of the disclosure, a non-transitory computer-readable medium having program code recorded thereon, the program code includes: code for receiving a synchronization signal block (SSB) from a first wireless communication device, wherein the SSB is received via a first beam of a plurality of beams from the first wireless communication device; code for acquiring configuration information specific to the first beam for using an initial downlink bandwidth part and an initial uplink bandwidth part, based on the SSB; and code for negotiating with the first wireless communication device on the first beam using the initial downlink bandwidth part and the initial uplink bandwidth part.

In yet another aspect of the disclosure, an apparatus includes means for receiving a synchronization signal block (SSB) from a first wireless communication device via a first beam of a plurality of beams from the first wireless communication device; means for acquiring configuration information specific to the first beam for using an initial downlink bandwidth part and an initial uplink bandwidth part, based on the SSB; and means for communicating between the first wireless communication device and a second wireless communication device on the first beam using the initial downlink bandwidth part and the initial uplink bandwidth part.

In another aspect, an apparatus includes a transceiver configured to: transmit a synchronization signal block (SSB) from a first wireless communication device, wherein the SSB is transmitted via a first beam of a plurality of beams from the first wireless communication device, wherein information in the SSB leads to configuration information specific to the first beam for using an initial downlink bandwidth part and an initial uplink bandwidth part; and a processor configured to: communicate between the first wireless communication device and a second wireless communication device on the first beam using the initial downlink bandwidth part and the initial uplink bandwidth part.

In another aspect, an apparatus includes means for transmitting a synchronization signal block (SSB) from a first wireless communication device, wherein the SSB is transmitted via a first beam of a plurality of beams from the first wireless communication device, wherein information in the SSB leads to configuration information specific to the first beam for using an initial downlink bandwidth part and an initial uplink bandwidth part; and means for communicating between the first wireless communication device and a second wireless communication device on the first beam using the initial downlink bandwidth part and the initial uplink bandwidth part.

In another aspect, a method of wireless communication includes: receiving a synchronization signal block (SSB) from a first wireless communication device; acquiring information from the SSB, wherein the information from the SSB leads to configuration information for using an initial downlink bandwidth part and an initial uplink bandwidth part; and communicating between the first wireless communication device and a second wireless communication device using the initial downlink bandwidth part and the initial uplink bandwidth part.

In another aspect, an apparatus includes: a transceiver configured to: receive a synchronization signal block (SSB) from a first wireless communication device; and a processor configured to: acquire information from the SSB which leads to configuration information for using an initial downlink bandwidth part and an initial uplink bandwidth part; and negotiate with the first wireless communication device using the initial downlink bandwidth part and the initial uplink bandwidth part.

In another aspect, a non-transitory computer-readable medium having program code recorded thereon includes: code for receiving a synchronization signal block (SSB) from a first wireless communication device; code for acquiring information from the SSB which leads to configuration information for using an initial downlink bandwidth part and an initial uplink bandwidth part; and code for negotiating with the first wireless communication device using the initial downlink bandwidth part and the initial uplink bandwidth part.

In another aspect, an apparatus includes: means for receiving a synchronization signal block (SSB) from a first wireless communication device; means for acquiring information from the SSB which leads to configuration information for using an initial downlink bandwidth part and an initial uplink bandwidth part; and means for communicating between the first wireless communication device and a second wireless communication device using the initial downlink bandwidth part and the initial uplink bandwidth part.

In another aspect, an apparatus includes: means for receiving a synchronization signal block (SSB) from a first wireless communication device; means for acquiring information from the SSB which leads to configuration information for using an initial downlink bandwidth part and an initial uplink bandwidth part; and means for communicating between the first wireless communication device and a second wireless communication device using the initial downlink bandwidth part and the initial uplink bandwidth part.

In another aspect, a method of wireless communication includes: transmitting a synchronization signal block (SSB) from a first wireless communication device, wherein information in the SSB leads to configuration information for using an initial downlink bandwidth part and an initial uplink bandwidth part; and communicating between the first wireless communication device and a second wireless communication device using the initial downlink bandwidth part and the initial uplink bandwidth part.

In another aspect, an apparatus includes: a transceiver configured to: transmit a synchronization signal block (SSB) from a first wireless communication device, wherein information in the SSB leads to configuration information for using an initial downlink bandwidth part and an initial uplink bandwidth part; and a processor configured to: communicate between the first wireless communication device and a second wireless communication device using the initial downlink bandwidth part and the initial uplink bandwidth part.

In another aspect, an apparatus includes: means for transmitting a synchronization signal block (SSB) from a first wireless communication device, wherein information in the SSB leads to configuration information for using an initial downlink bandwidth part and an initial uplink bandwidth part; and means for communicating between the first wireless communication device and a second wireless communication device using the initial downlink bandwidth part and the initial uplink bandwidth part.

Other aspects, features, and embodiments of the present disclosure will become apparent to those of ordinary skill in the art, upon reviewing the following description of specific, exemplary embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the disclosure discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 illustrates a wireless communication network according to some aspects of the present disclosure.

FIG. 2 illustrates a radio frame structure according to some aspects of the present disclosure.

FIG. 3 illustrates an example beam pattern according to some aspects of the present disclosure.

FIG. 4 illustrates an example relationship between beams, synchronization signal blocks (SSBs), and frequencies according to some aspects of the present disclosure.

FIG. 5 illustrates a block diagram of an example SSB, according to some aspects of the present disclosure.

FIG. 6 is a block diagram of a user equipment (UE) according to some aspects of the present disclosure.

FIG. 7 is a block diagram of an exemplary base station (BS) according to some aspects of the present disclosure.

FIG. 8 is an illustration of an example initial access method according to some aspects of the present disclosure.

FIG. 9 is an illustration of an example initial access method according to some aspects of the present disclosure.

FIG. 10 is an illustration of an example initial access method according to some aspects of the present disclosure.

FIG. 11 is an illustration of an example initial access method according to some aspects of the present disclosure.

FIG. 12 is an illustration of an example relationship of a non-terrestrial network resource with a base station and core network according to some aspects of the present disclosure.

FIG. 13 is a flow diagram of a communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-Advanced are considered in addition to development of the new radio technology for 5G NR networks. The 5G NR will be capable of scaling to provide coverage (1) to a massive Internet of things (IoTs) with a Ultra-high density (e.g., ˜1M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgment in the same subframe. The self-contained integrated subframe supports communications in unlicensed or contention-based shared spectrum, adaptive uplink /downlink that may be flexibly configured on a per-cell basis to dynamically switch between UL and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

Some NR technologies include multiple beams, where each beam may be used by one or more UEs to communicate with a base station (BS). For instance, a wireless communication network may operate over a high frequency band, such as a mmWave band, to provision for a high data throughput. To overcome the high path-loss in the high frequency band, a BS may transmit reference signals and/or synchronization signal blocks (SSBs) in different beam directions, for example, by sweeping across a set of predefined beam directions. The BS may repeat the transmissions of the reference signals and/or SSBs in the different beam directions to allow a user equipment (UE) to perform signal measurements. The UE may report the measurements to the BS. The BS and the UE may select a best beam direction among the set of beam directions for subsequent communications. In some instances, the initially selected beam direction may not be optimal, or the channel condition may change, and thus the BS and the UE may perform a beam refinement procedure to refine a beam selection. For instance, the initial selected beam may have a wide beam-width for a broad coverage area and the beam refinement procedure may select a narrower beam in the initially selected direction. The narrower beam may cover a smaller geographical area but may provide a higher transmission gain. The narrow beam with the higher gain can provide a higher signal-to-noise ratio (SNR) than the wide beam. In some instances, the channel condition may degrade, and/or the UE may move out of a coverage of a currently selected beam, and thus the UE may steer the beam to improve communication with the UE. Additionally, or alternatively, the UE may detect a radio link failure in response to channel condition degradation, which may be referred to as a beam failure. Upon detecting a beam failure, the UE may perform a beam failure recovery (BFR) procedure with the BS to request communication over a different beam. Moving from one beam to another beam, without switching cells, may be considered beam handover.

However, some NR technologies may not be amenable to beam steering. As an example, some non-terrestrial network (NTN) applications, such as satellites, may include multiple fixed arrays of antennas but be designed for fixed, rather than steerable, beams. An example satellite may be treated as a single cell with multiple beams. As the satellite moves in orbit around the earth, its beams may also move relative to the Earth's surface, so that a UE which communicates data by a first beam may detect that the first beam has failed. Therefore, the UE may perform beam handover to be assigned a second beam for data communication.

Some example systems use multiple beams that are physically spaced apart but may use a same portion of bandwidth or a bandwidth part (BWP). In such systems, beam assignment may also include BWP assignment.

According to some implementations of the present disclosure, techniques for assigning BWP are disclosed herein. In one example implementation, an initial access process is provided, which allows a UE to acquire configuration information specific to a beam for receiving an initial downlink BWP and an initial uplink BWP. The UE may then communicate with the base station on the first beam using the initial downlink BWP and the initial uplink BWP to further configure the UE to use a dedicated BWP for data communication.

Continuing with the example, one initial access process uses a system information block (SIB) that includes configuration information specific to the first beam in addition to other configuration information specific to a second beam. Thus, the SIB may be used to carry beam-specific configuration information for multiple beams. When the UE decodes the SIB, it parses the contents to identify the beam-specific information for that particular UE by, e.g., matching a SSB time index for the first beam to a time index listed in the information of the SIB. Another UE on a different beam would be expected to perform the same process, though when it parses the SIB, it matches a different time index to different information in the SIB. The UE uses the information in the SIB to receive the initial downlink BWP and the initial uplink BWP for its beam and uses the first beam and the initial BWPs for further configuration communication with the BS in order to be assigned a dedicated BWP for data communication.

In other example implementations, the initial access process may branch earlier than the SIB to provide beam-specific configuration information. Thus, in one example, an SSB may point to a master information block (MIB), which includes beam-specific control resource sets. In another example, SSBs may be specific to beams. Each of these additional examples allow the UE to receive the initial uplink and downlink BWPs, which the UE uses to communicate with the BS to be assigned a dedicated BWP for data communication.

Aspects of the present disclosure can provide several benefits. For example, as noted above, some NR applications may be less amenable to beam steering. Various implementations described herein provide reliable techniques for assigning BWPs to UEs that communicate in beams, thereby facilitating beam handover. For instance, satellites or other NTN resources, which may not support beam steering, and the UEs which communicate with the NTN resources may be configured to perform the initial access processes of the present disclosure so that a UE may be handed over from one beam to another as the NTN resource moves. Such process may allow a BS or other NTN resource to be treated as a single cell with multiple beams, thereby avoiding cell handover, which is generally expected to incur more overhead than beam handover. In other words, various implementations of the disclosure may reduce overhead in a wireless communication system by allowing wireless communication devices to perform beam handover, while avoiding or minimizing cell handover.

Of course, various implementations of the disclosure are not limited to satellites and other NTN resources. Rather, aspects of the present disclosure may be applied to terrestrial resources as well, where the initial access process may be employed in addition to, or instead of, beam steering or other beam failure techniques.

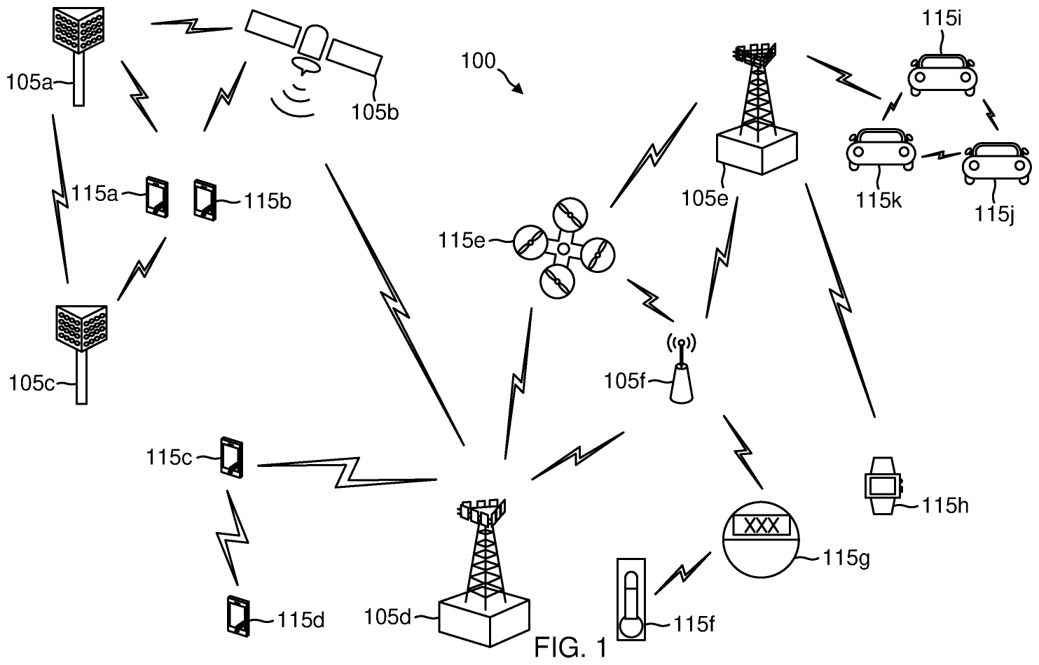

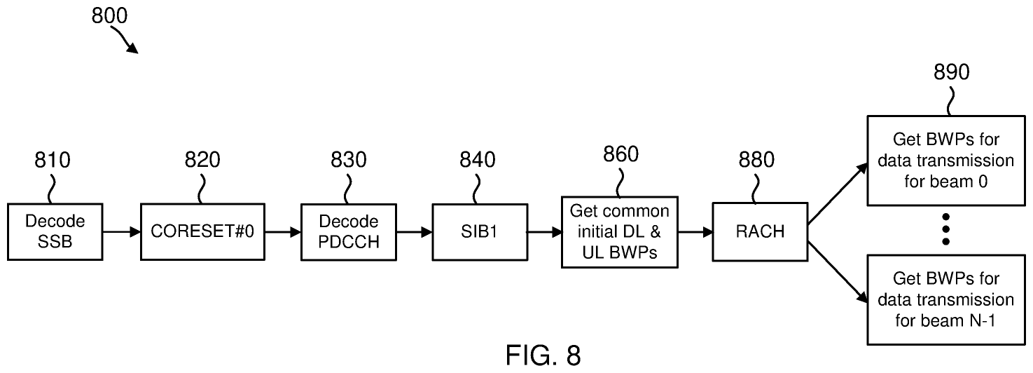

FIG. 1 illustrates a wireless communication network 100 according to some aspects of the present disclosure. The network 100 may be a 5G network. The network 100 includes a number of base stations (BSs) 105 (individually labeled as 105a, 105b, 105c, 105d, 105e, and 105f) and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used. The actions of FIGS. 8-13 may be performed by any of BSs 105 and UEs 115.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105b, 105d, and 105e may be regular macro BSs, while the BSs 105a and 105c may be macro BSs enabled with one of three dimension (3D), full dimension (FD), or massive MIMO. The BSs 105a and 105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a and 105c may serve the UEs 115a and 115b using 3D beamforming and coordinated spatial techniques, such as coordinated multipoint (CoMP) or multi-connectivity. The macro BS 105d may perform backhaul communications with the BSs 105a and 105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of a gNB or an access node controller (ANC)) may interface with the core network through backhaul links (e.g., NG-C, NG-U, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a drone. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-step-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as vehicle-to-vehicle (V2V), vehicle-to-everything (V2X), cellular-V2X (C-V2X) communications between a UE 115i, 115j, or 115k and other UEs 115, and/or vehicle-to-infrastructure (V2I) communications between a UE 115i, 115j, or 115k and a BS 105. Additionally, BS 105b is shown as a NTN resource, such as a satellite that orbits the earth. In this example, BS 105b may include multiple antenna arrays, each array forming a relatively fixed beam. BS 105b may be configured as a single cell with multiple beams and BWPs, as explained in more detail below.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some aspects, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for example, about 10. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information—reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some aspects, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining system information (RMSI), and other system information (OSI)) to facilitate initial network access. In some instances, the BSs 105 may broadcast the PSS, the SSS, and/or the MIB in the form of synchronization signal block (SSBs) over a physical broadcast channel (PBCH) and may broadcast the RMSI and/or the OSI over a physical downlink shared channel (PDSCH).

In some aspects, a UE 115 attempting to access the network 100 may perform an initial cell search by detecting a PSS from a BS 105. The PSS may enable synchronization of period timing and may indicate a physical layer identity value. The UE 115 may then receive a SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

After obtaining the MIB, the RMSI and/or the OSI, the UE 115 can perform a random access procedure to establish a connection with the BS 105. In some examples, the random access procedure may be a four-step random access procedure. For example, the UE 115 may transmit a random access preamble and the BS 105 may respond with a random access response. The random access response (RAR) may include a detected random access preamble identifier (ID) corresponding to the random access preamble, timing advance (TA) information, a UL grant, a temporary cell-radio network temporary identifier (C-RNTI), and/or a backoff indicator. Upon receiving the random access response, the UE 115 may transmit a connection request to the BS 105 and the BS 105 may respond with a connection response. The connection response may indicate a contention resolution. In some examples, the random access preamble, the RAR, the connection request, and the connection response can be referred to as message 1 (MSG1), message 2 (MSG2), message 3 (MSG3), and message 4 (MSG4), respectively. In some examples, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit a UL communication signal to the BS 105 via a PUSCH and/or PUCCH according to a UL scheduling grant.

In some aspects, the BS 105 may communicate with a UE 115 using hybrid automatic repeat request (HARQ) techniques to improve communication reliability, for example, to provide an ultra-reliable low-latency communication (URLLC) service. The BS 105 may schedule a UE 115 for a PDSCH communication by transmitting a DL grant in a PDCCH. The BS 105 may transmit a DL data packet to the UE 115 according to the schedule in the PDSCH. The DL data packet may be transmitted in the form of a transport block (TB). If the UE 115 receives the DL data packet successfully, the UE 115 may transmit a HARQ acknowledgment (ACK) to the BS 105. Conversely, if the UE 115 fails to receive the DL transmission successfully, the UE 115 may transmit a HARQ negative-acknowledgment (NACK) to the BS 105. Upon receiving a HARQ NACK from the UE 115, the BS 105 may retransmit the DL data packet to the UE 115. The retransmission may include the same coded version of DL data as the initial transmission. Alternatively, the retransmission may include a different coded version of the DL data than the initial transmission. The UE 115 may apply soft-combining to combine the encoded data received from the initial transmission and the retransmission for decoding. The BS 105 and the UE 115 may also apply HARQ for UL communications using substantially similar mechanisms as the DL HARQ.

In some aspects, the network 100 may operate over a system BW or a component carrier (CC) BW. The network 100 may partition the system BW into multiple BWPs (e.g., portions). A BS 105 may dynamically assign a UE 115 to operate over a certain BWP (e.g., a certain portion of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For example, the BWP pair may include one BWP for UL communications and one BWP for DL communications.

In some aspects, the network 100 may operate over a shared channel, which may include shared frequency bands or unlicensed frequency bands. For example, the network 100 may be an NR-unlicensed (NR-U) network. The BSs 105 and the UEs 115 may be operated by multiple network operating entities. To avoid collisions, the BSs 105 and the UEs 115 may employ a listen-before-talk (LBT) procedure to monitor for transmission opportunities (TXOPs) in the shared channel. For example, a transmitting node (e.g., a BS 105 or a UE 115) may perform an LBT prior to transmitting in the channel. When the LBT passes, the transmitting node may proceed with the transmission. When the LBT fails, the transmitting node may refrain from transmitting in the channel. In an example, the LBT may be based on energy detection. For example, the LBT results in a pass when signal energy measured from the channel is below a threshold. Conversely, the LBT results in a failure when signal energy measured from the channel exceeds the threshold. In another example, the LBT may be based on signal detection. For example, the LBT results in a pass when a channel reservation signal (e.g., a predetermined preamble signal) is not detected in the channel.

In some aspects, the network 100 may operate over a high frequency band, for example, in a frequency range 1 (FR1) band or a frequency range 2 (FR2) band. FR1 may refer to frequencies in the sub-6 GHz range and FR2 may refer to frequencies in the mmWave range. To overcome the high path-loss at high frequency, the BSs 105 and the UEs 115 may communicate with each other using directional beams. For instance, a BS 105 may transmit SSBs by sweeping across a set of predefined beam directions and may repeat the SSB transmissions at a certain time interval in the set of beam directions to allow a UE 115 to perform initial network access. In the example of BS 105b (shown as an NTN resource), it may transmit SSBs on each of its beams at scheduled times, even if the beams do not steer. In some instances, each beam and its corresponding characteristics may be identified by a beam index. For instance, each SSB may include an indication of a beam index corresponding to the beam used for the SSB transmission. The UE 115 may determine signal measurements, such as reference signal received power (RSRP) and/or reference signal received quality (RSRQ), for the SSBs at the different beam directions and select a best DL beam. The UE 115 may indicate the selection by transmitting a physical random access channel (PRACH) signal (e.g., MSG1) using PRACH resources associated with the selected beam direction. For instance, the SSB transmitted in a particular beam direction or on a particular beam may indicate PRACH resources that may be used by a UE 115 to communicate with the BS 105 in that particular beam direction. After selecting the best DL beam, the UE 115 may complete the random access procedure (e.g., the 4-step random access or the 2-step random access) and proceed with network registration and normal operation data exchange with the BS 105. In some instances, the initially selected beams may not be optimal or the channel condition may change, and thus the BS 105 and the UE 115 may perform a beam refinement procedure to refine a beam selection. For instance, BS 105 may transmit CSI-RSs by sweeping narrower beams over a narrower angular range and the UE 115 may report the best DL beam to the BS 105. When the BS 105 uses a narrower beam for transmission, the BS 105 may apply a higher gain, and thus may provide a better performance (e.g., a higher signal-noise-ratio (SNR)). In some instances, the channel condition may degrade and/or the UE 115 may move out of a coverage of an initially selected beam, and thus the UE 115 may detect a beam failure condition. Upon detecting a beam failure, the UE 115 may perform beam handover.

In some aspects, the network 100 may be an IoT network and the UEs 115 may be IoT nodes, such as smart printers, monitors, gaming nodes, cameras, audio-video (AV) production equipment, industrial IoT devices, and/or the like. The transmission payload data size of an IoT node typically may be relatively small, for example, in the order of tens of bytes. In some aspects, the network 100 may be a massive IoT network serving tens of thousands of nodes (e.g., UEs 115) over a high frequency band, such as a FR1 band or a FR2 band.

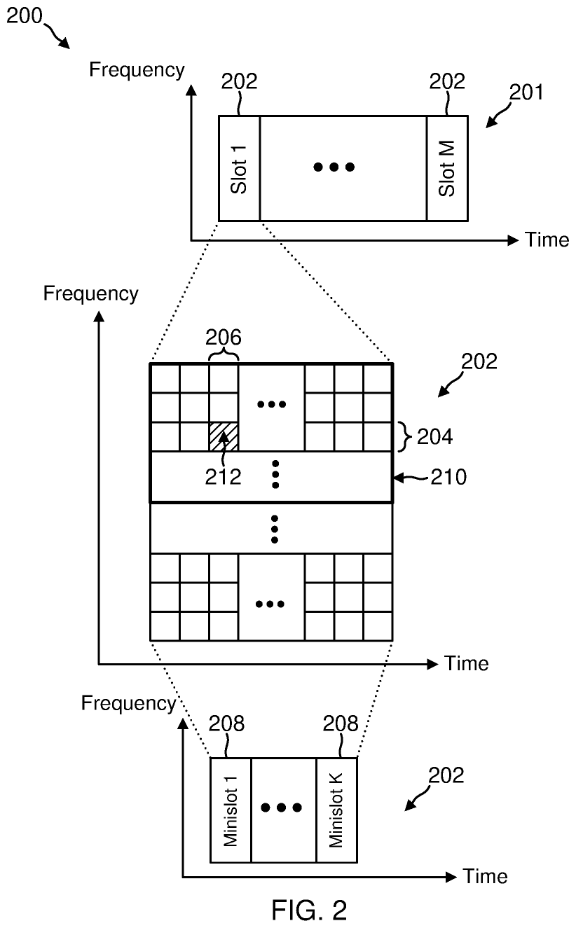

FIG. 2 is a timing diagram illustrating a radio frame structure 200 according to some aspects of the present disclosure. The radio frame structure 200 may be employed by BSs such as the BSs 105 and UEs such as the UEs 115 in a network such as the network 100 for communications. In particular, the BS may communicate with the UE using time-frequency resources configured as shown in the radio frame structure 200. In FIG. 2, the x-axes represent time in some arbitrary units and the y-axes represent frequency in some arbitrary units. The radio frame structure 200 includes a radio frame 201. The duration of the radio frame 201 may vary depending on the aspects. In an example, the radio frame 201 may have a duration of about ten milliseconds. The radio frame 201 includes M number of slots 202, where M may be any suitable positive integer. In an example, M may be about 10.

Each slot 202 includes a number of subcarriers 204 in frequency and a number of symbols 206 in time. The number of subcarriers 204 and/or the number of symbols 206 in a slot 202 may vary depending on the aspects, for example, based on the channel bandwidth, the subcarrier spacing (SCS), and/or the cellular processor (CP) mode. One subcarrier 204 in frequency and one symbol 206 in time forms one resource element (RE) 212 for transmission. A resource block (RB) 210 is formed from a number of consecutive subcarriers 204 in frequency and a number of consecutive symbols 206 in time.

In an example, a BS (e.g., BS 105 in FIG. 1) may schedule a UE (e.g., UE 115 in FIG. 1) for UL and/or DL communications at a time-granularity of slots 202 or mini-slots 208. Each slot 202 may be time-partitioned into K number of mini-slots 208. Each mini-slot 208 may include one or more symbols 206. The mini-slots 208 in a slot 202 may have variable lengths. For example, when a slot 202 includes N number of symbols 206, a mini-slot 208 may have a length between one symbol 206 and (N-1) symbols 206. In some aspects, a mini-slot 208 may have a length of about two symbols 206, about four symbols 206, or about seven symbols 206. In some examples, the BS may schedule UE at a frequency-granularity of a resource block (RB) 210 (e.g., including about 12 subcarriers 204).

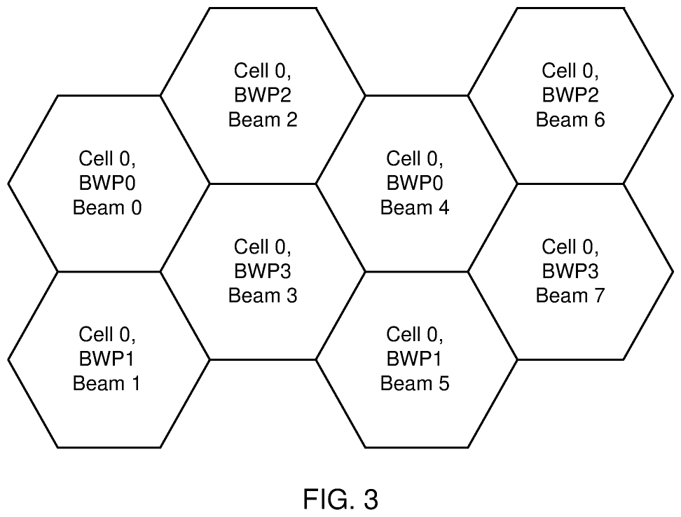

FIG. 3 illustrates a beam pattern, associated with a NTN resource, such as BS 105b, as the beams are projected onto the surface of the earth, according to some aspects of the present disclosure. The example of FIG. 3 shows eight beams, beam 0-beam 7, and four BWPs, BWP 0-BWP 3. However, the scope of implementations is not limited to any particular number of beams or BWPs. Furthermore, a satellite, such as illustrated by BS 105b, may move relative to the earth's surface as it orbits the earth. The satellites movement causes the beams' projections to move as well, so that a UE on the surface of the earth may have acceptable reception for a particular beam at a particular time, but that reception may change as the satellite moves, so that the UE may perform a handover from one beam to another.

It is further noted that in the example of FIG. 3, beams 0-7 represent dedicated beams and BWPs for data transmission. By comparison, uplink and downlink BWPs may be assigned to common frequencies. In this example, beams 0-7 belong to a same cell, and the BWPs are shared among the beams according to a spatial reuse of frequency. Looking to beam 0, it is associated with BWP 0, as is beam 4. However, beam 0 and beam 4 are physically spaced apart to ensure little or no interference. Similarly, beam 1 and beam 5 also share BWP 1 but are spaced apart physically.

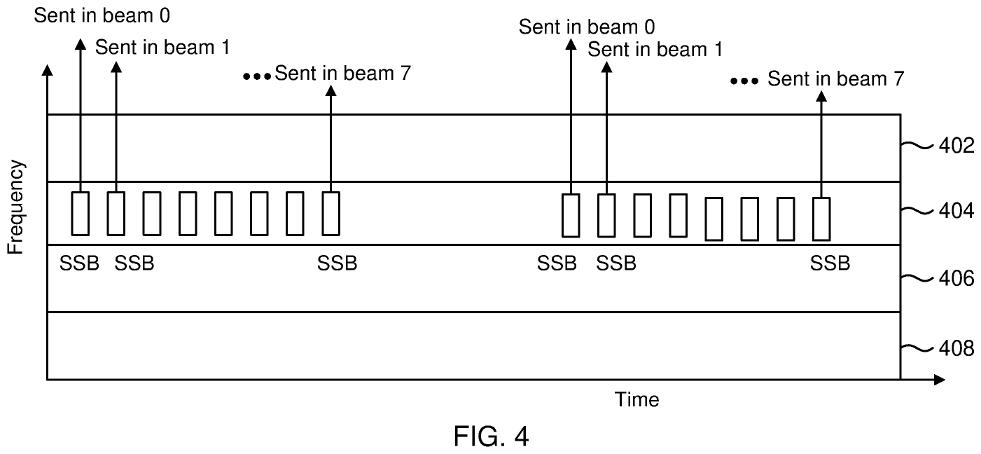

FIG. 4 illustrates a wireless communication technique according to some aspects of the present disclosure. Specifically, FIG. 4 illustrates a technique for broadcasting SSBs. As noted above, each of the SSBs may be transmitted from a BS at a particular time and be associated with a particular time index. Such relationship is illustrated in FIG. 4, where a first SSB is sent in beam 0, a second SSB is sent in beam 1, and on and on so that an eighth SSB is sent in beam 7, and this pattern repeats as time goes on. In other words, the network transmits the eight SSBs sequentially in time across the beams over a common frequency range, and each SSB corresponds to a particular beam.

FIG. 4 also shows four different frequency bands 402-408. Frequency band 402 corresponds to a portion of the spectrum used by BWP 1. Frequency band 404 corresponds to a portion of the spectrum used by BWP 0. Frequency band 406 corresponds to a portion of the spectrum used by BWP 3, and frequency band 408 corresponds to a portion of the spectrum used by BWP 2. Note that the SSBs are sent using frequency band 404, indicating that a portion of the spectrum in which the SSBs reside is contained within BWP 0. Of course, the scope of implementations is not limited to the relationship shown in FIG. 4. Rather, in some implementations, the common frequency range for the SSBs may be partially contained in one or more of the BWPs, or may not overlap any of the BWPs. An advantage of the implementation shown in FIG. 4 is that the totality of the common frequency range and the BWPs is smaller than if the common frequency range was separated from the BWPs, thereby providing efficiency of spectrum. On the other hand, an advantage of separating the common frequency range of the SSBs from the BWPs is that the data transmissions associated with the BWPs may proceed without regard to timing of the SSBs, thereby providing higher data throughput.

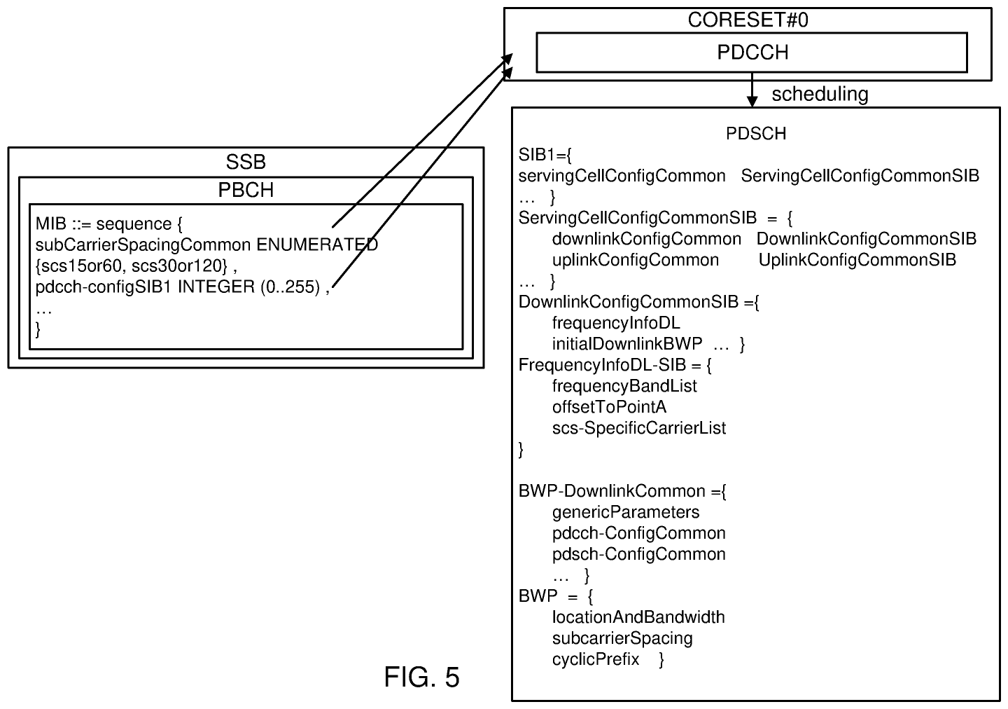

FIG. 5 is an illustration of a process of starting from an SSB to obtain the information about an initial downlink BWP and an initial uplink BWP part, according to one some aspects of the present disclosure. For instance, SSBs are illustrated in the example of FIG. 4, and the SSBs of FIG. 5 may be used in the example of FIG. 4 and in other examples described herein. In this implementation, the SSB includes a PBCH that carries MIB. A UE that receives the SSB decodes the SSB to acquire the MIB. The UE then parses the contents of the MIB, which point to a common CORESET #0. The CORESET #0 includes a Physical Downlink Control Channel (PDCCH) and the PDCCH schedules SIB1 on a PDSCH, and the SIB1, has information elements to identify an initial downlink BWP and an initial uplink BWP. The UE parses the contents of the SIB1, finds its initial downlink BWP and its initial uplink BWP and then uses the initial downlink BWP and uplink BWP to communicate with the BS for further configuration. For instance, the UE may communicate with the BS to be assigned a dedicated BWP on a particular beam for data transmission. Of course, some aspects of the disclosure may use a different MIB, a different CORESET #0, or a different SIB1, as described further below.

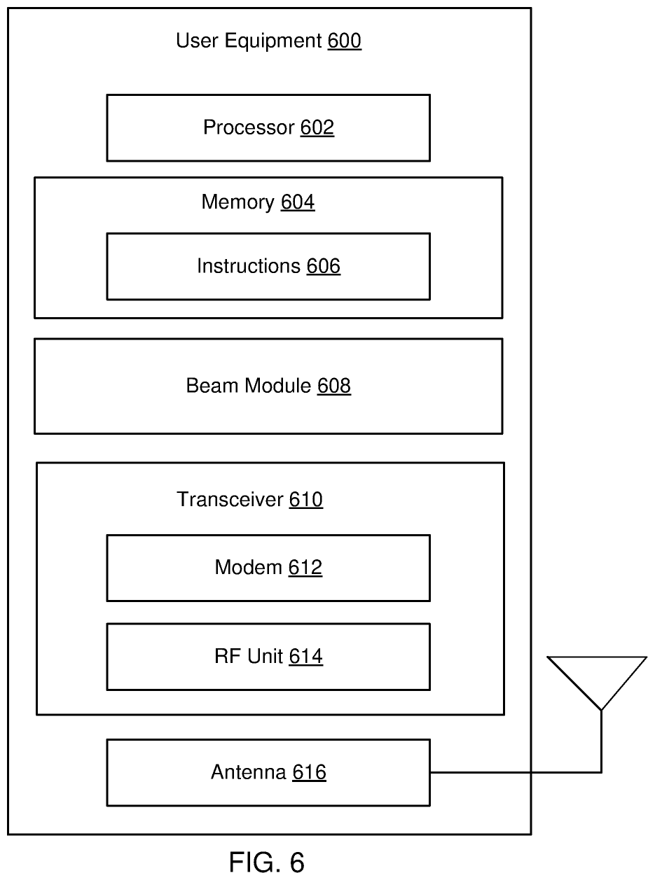

FIG. 6 is a block diagram of an exemplary UE 600 according to some aspects of the present disclosure. The UE 600 may be a UE 115 discussed above in FIG. 1. As shown, the UE 600 may include a processor 602, a memory 604, a beam module 608, a transceiver 610 including a modem subsystem 612 and a radio frequency (RF) unit 614, and one or more antennas 616. These elements may be in direct or indirect communication with each other, for example via one or more buses.

The processor 602 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 602 may also be implemented as a combination of computing devices, e.g., a combination of a DSP and a microprocessor, a plurality of microprocessors, one or more microprocessors in conjunction with a DSP core, or any other such configuration.

The memory 604 may include a cache memory (e.g., a cache memory of the processor 602), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an aspect, the memory 604 includes a non-transitory computer-readable medium. The memory 604 may store, or have recorded thereon, instructions 606. The instructions 606 may include instructions that, when executed by the processor 602, cause the processor 602 to perform the operations described herein with reference to the UEs 115 in connection with aspects of the present disclosure, for example, aspects of FIGS. 8-13. Instructions 606 may also be referred to as program code. The program code may be for causing a wireless communication device to perform these operations, for example by causing one or more processors (such as processor 602) to control or command the wireless communication device to do so. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The beam module 608 may be implemented via hardware, software, or combinations thereof. For example, the beam module 608 may be implemented as a processor, circuit, and/or instructions 606 stored in the memory 604 and executed by the processor 602. In some instances, the beam module 608 can be integrated within the modem subsystem 612. For example, the beam module 608 can be implemented by a combination of software components (e.g., executed by a DSP or a general processor) and hardware components (e.g., logic gates and circuitry) within the modem subsystem 612.

The beam module 608 may be used for various aspects of the present disclosure, for example, aspects of FIGS. 8-13. The beam module 608 is configured to receive SSBs from a BS (e.g., the BSs 105 and/or 305) in various beams directions, receive a CSI-RS resource configuration from the BS, receive a BFR resource configuration from the BS, receive CSI-RSs from various beam directions based in the CSI-RS resource configuration, determine beam measurements (e.g., RSRPs and/or RSRQs) for the received SSBs and/or CSI-RSs, report beam feedback information (e.g., including the measurements) to the BS, perform beam selection with the BS to select an optimal beam for communication with the BS, monitor beam measurements, request beam refinement, and/or request BFR when beam measurements fall below certain thresholds, receive a beam switch command from the BS, and/or perform a beam switch based on a beam switch command. In some aspects, beam module 608 is configured to configure the transceiver 610 to perform digital beamforming and/or analog beamforming to generate reception beams in certain directions for receiving DL signals from the BS and/or to generate transmission beams in certain directions for transmitting UL signals to the BS.

Additionally, in this example, beam module 608 may be used to perform the techniques described herein with respect to FIGS. 8-13 for initial access to be assigned initial BWPs and be assigned a dedicated BWP for data transmission.

As shown, the transceiver 610 may include the modem subsystem 612 and the RF unit 614. The transceiver 610 can be configured to communicate bi-directionally with other devices, such as the BSs 105. The modem subsystem 612 may be configured to modulate and/or encode the data from the memory 604 and/or the beam module 608 according to a modulation and coding scheme (MCS), e.g., a low-density parity check (LDPC) coding scheme, a turbo coding scheme, a convolutional coding scheme, a digital beamforming scheme, etc. The RF unit 614 may be configured to process (e.g., perform analog to digital conversion or digital to analog conversion, etc.) modulated/encoded data (e.g., PUCCH control information, PRACH signals, PUSCH data, beam refinement request, BFR request, beam switch command, reference signals) from the modem subsystem 612 (on outbound transmissions) or of transmissions originating from another source such as a UE 115 or a BS 105. The RF unit 614 may be further configured to perform analog beamforming in conjunction with the digital beamforming. Although shown as integrated together in transceiver 610, the modem subsystem 612 and the RF unit 614 may be separate devices that are coupled together at the UE 115 to enable the UE 115 to communicate with other devices.

The RF unit 614 may provide the modulated and/or processed data, e.g. data packets (or, more generally, data messages that may contain one or more data packets and other information), to the antennas 616 for transmission to one or more other devices. The antennas 616 may further receive data messages transmitted from other devices. The antennas 616 may provide the received data messages for processing and/or demodulation at the transceiver 610. The transceiver 610 may provide the demodulated and decoded data (e.g., SSBs, PDCCH, PDSCH, beam switch command, CSI-RS resource configuration, CSI-RS reporting configuration, BFR resource configuration) to the beam module 608 for processing. The antennas 616 may include multiple antennas of similar or different designs in order to sustain multiple transmission links. The RF unit 614 may configure the antennas 616.

In an aspect, the UE 600 can include multiple transceivers 610 implementing different RATs (e.g., NR and LTE). In an aspect, the UE 600 can include a single transceiver 610 implementing multiple RATs (e.g., NR and LTE). In an aspect, the transceiver 610 can include various components, where different combinations of components can implement different RATs.

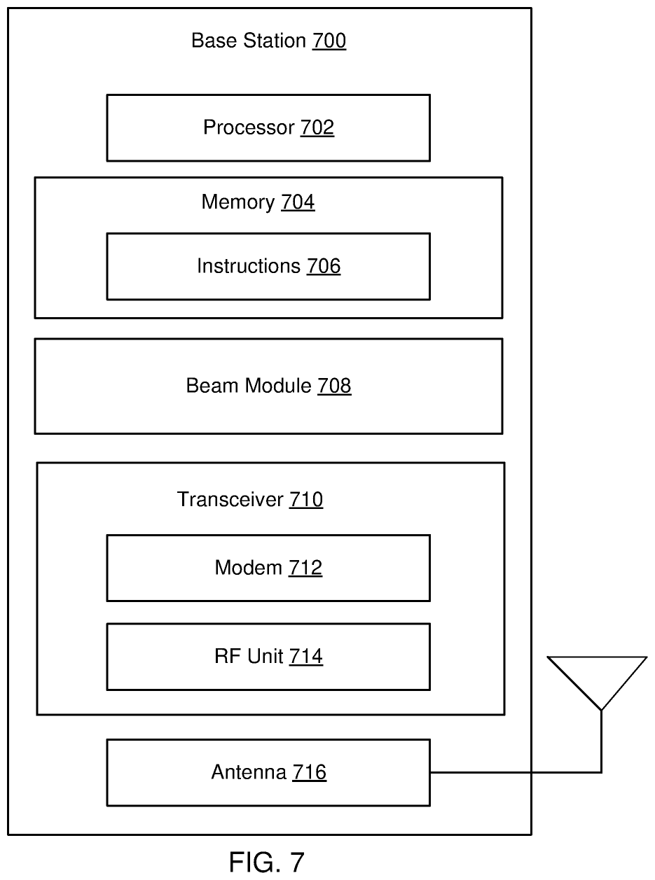

FIG. 7 is a block diagram of an exemplary BS 700 according to some aspects of the present disclosure. The BS 700 may be a BS 105 in the network 100 as discussed above in FIG. 1. A shown, the BS 700 may include a processor 702, a memory 704, a beam module 708, a transceiver 710 including a modem subsystem 712 and a RF unit 714, and one or more antennas 716. These elements may be in direct or indirect communication with each other, for example via one or more buses.

The processor 702 may have various features as a specific-type processor. For example, these may include a CPU, a DSP, an ASIC, a controller, a FPGA device, another hardware device, a firmware device, or any combination thereof configured to perform the operations described herein. The processor 702 may also be implemented as a combination of computing devices, e.g., a combination of a DSP and a microprocessor, a plurality of microprocessors, one or more microprocessors in conjunction with a DSP core, or any other such configuration.

The memory 704 may include a cache memory (e.g., a cache memory of the processor 702), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some aspects, the memory 704 may include a non-transitory computer-readable medium. The memory 704 may store instructions 706. The instructions 706 may include instructions that, when executed by the processor 702, cause the processor 702 to perform operations described herein, for example, aspects of FIGS. 8-13. Instructions 706 may also be referred to as code, which may be interpreted broadly to include any type of computer-readable statement(s) as discussed above with respect to FIG. 6.

The beam module 708 may be implemented via hardware, software, or combinations thereof. For example, the beam module 708 may be implemented as a processor, circuit, and/or instructions 706 stored in the memory 704 and executed by the processor 702. In some instances, the beam module 708 can be integrated within the modem subsystem 712. For example, the beam module 708 can be implemented by a combination of software components (e.g., executed by a DSP or a general processor) and hardware components (e.g., logic gates and circuitry) within the modem subsystem 712.

The beam module 708 may be used for various aspects of the present disclosure, for example, aspects of aspects of FIGS. 8-13 for initial BWP assignment and assignment of dedicated BWP for data transmission.

As shown, the transceiver 710 may include the modem subsystem 712 and the RF unit 714. The transceiver 710 can be configured to communicate bi-directionally with other devices, such as the UEs 115 and/or 300 and/or another core network element. The modem subsystem 712 may be configured to modulate and/or encode data according to a MCS, e.g., a LDPC coding scheme, a turbo coding scheme, a convolutional coding scheme, a digital beamforming scheme, etc. The RF unit 714 may be configured to process (e.g., perform analog to digital conversion or digital to analog conversion, etc.) modulated/encoded data (e.g., SSBs, RMSI, MIB, SIB, frame based equipment—FBE configuration, PRACH configuration PDCCH, PDSCH) from the modem subsystem 712 (on outbound transmissions) or of transmissions originating from another source such as a UE 115, the node 315, and/or BS 700. The RF unit 714 may be further configured to perform analog beamforming in conjunction with the digital beamforming. Although shown as integrated together in transceiver 710, the modem subsystem 712 and/or the RF unit 714 may be separate devices that are coupled together at the BS 105 to enable the BS 105 to communicate with other devices.

The RF unit 714 may provide the modulated and/or processed data, e.g. data packets (or, more generally, data messages that may contain one or more data packets and other information), to the antennas 716 for transmission to one or more other devices. The antennas 716 may be similar to the antennas 302 of the BS 305 discussed above. This may include, for example, transmission of information to complete attachment to a network and communication with a camped UE 115 or 215 according to some aspects of the present disclosure. The antennas 716 may further receive data messages transmitted from other devices and provide the received data messages for processing and/or demodulation at the transceiver 710. The transceiver 710 may provide the demodulated and decoded data (e.g., PUCCH control information, PRACH signals, PUSCH data) to the beam module 708 for processing. The antennas 716 may include multiple antennas of similar or different designs in order to sustain multiple transmission links.

In an example, the transceiver 710 is configured to transmit, to a UE, system information including an FBE configuration indicating a plurality of frame periods, each including a gap period for contention at the beginning of the frame period, and communicate with the UE based on the FBE configuration, for example, by coordinating with the beam module 708.

In an aspect, the BS 700 can include multiple transceivers 710 implementing different RATs (e.g., NR and LTE). In an aspect, the BS 700 can include a single transceiver 710 implementing multiple RATs (e.g., NR and LTE). In an aspect, the transceiver 710 can include various components, where different combinations of components can implement different RATs.

FIG. 8 is a flow diagram of an initial access method 800 according to some aspects of the present disclosure. The method 800 may be implemented between any BS 105 and any UE 115 in the network 100 (shown in FIG. 1). For instance, the BS 105 may utilize one or more components, such as the processor 702, the memory 704, the beam module 708, the transceiver 710, and the one or more antennas 716, to execute the steps of method 800. Similarly, the UE 115 may utilize one or more components, such as the processor 602, the memory 604, the beam module 608, the transceiver 610, and the one or more antennas 616, to execute the steps of method 800. As illustrated, the method 800 includes a number of enumerated steps, but implementations of the method 800 may include additional steps before, after, and in between the enumerated steps. In some aspects, one or more of the enumerated steps may be omitted or performed in a different order.

At action 810, the UE 115 receives an SSB from the BS 105. The UE decodes the SSB. Each SSB carries information elements (IEs) pdcch-configSIB1 and subCarrierSpacingCommon, which together point to a common CORESET #0. An example is shown with respect to FIG. 5, where the SSB includes an MIB.

At actions 820-860, UE 115 parses a PDCCH included in the CORESET #0. The PDCCH schedules SIB1, which contains IE servingCellConfigCommon, which in turn contains IEs downlinkConfigCommon and uplinkConfigCommon, which in turn contain IEs initialDownlinkBWP and initialDownlinkBWP respectively.

At action 880, The UE 115 performs RACH access over the initial DL BWP and the initial UL BWP configured by IEs initialDownlinkBWP and initialDownlinkBWP, respectively. The UE obtains its DL BWPs and UL BWPs for data transmission if they are different from the initial downlink BWP and the initial uplink BWP. In one example, UE 115 performs RACH access with BS 105 using a first beam and the initial uplink BWP and the initial downlink BWP. For instance, the RACH access may employ a PRACH, which includes information indicating the beam that the particular UE 115 is in. At actions 880-890, the UE 115 and the BS 105 negotiate to assign a dedicated BWP on a particular beam for use by the UE 115 for data transmission.

Action 890 illustrates that different UEs 115 may be assigned different BWPs on different beams as appropriate. In fact, as noted above with respect to FIG. 3, some beams may share BWPs by using physical spacing. Other UEs 115 performing initial access may perform actions the same as or similar to actions 810-890 to receive respective BWPs. Action 890 may include the BS 105 allocating a particular beam and a BWP based at least in part on availability and physical separation with other beams and BWPs.

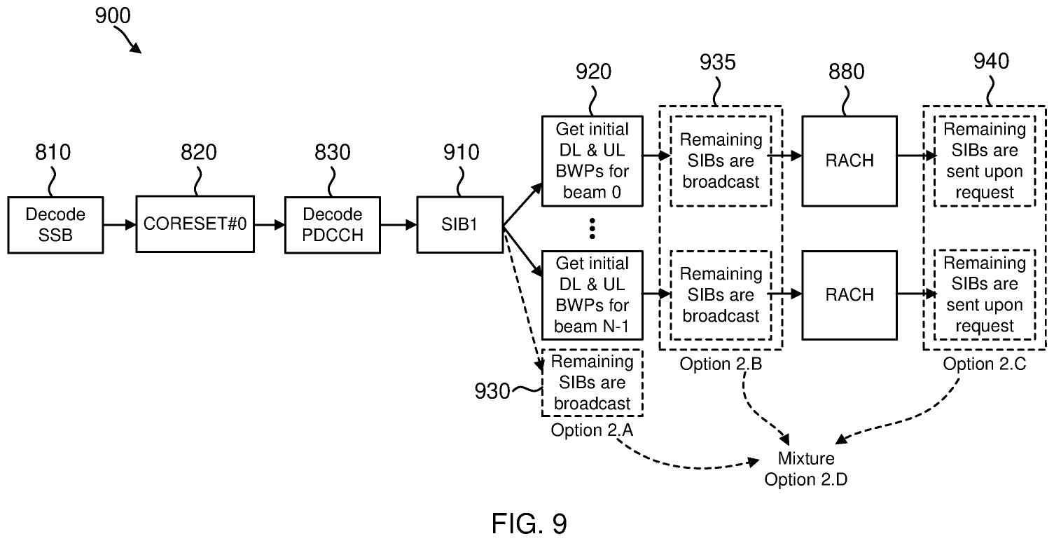

Furthermore, as noted above, the common frequency range, which is used to transmit the SSBs, may be contained in one of the BWPs (as in FIG. 4), may be partially contained in one or more of the BWPs, or may not overlap with any of the BWPs. This is true for the processes shown in FIGS. 9-13 as well.

FIG. 9 is a diagram similar to FIG. 8. However, in example method 900 of FIG. 9, the SIB1 includes beam-specific information. Actions 810-830 and 880 are the same as those described above with respect to FIG. 8.

At action 910, the UE 115 receives an SIB1 from the BS 105. In this example, the SIB1 includes configuration information specific to a first beam in addition to other configuration information specific to a second beam. Continuing with the example, UE 115 may select a beam by comparing one or more of the SSBs and finding an SSB with an acceptable channel condition or other criteria. Each SSB has its own respective time index and corresponds to one beam. The UE 115 may use the time index to parse the SIB1 to determine which configuration information corresponds to its beam.

In one example, the CORESET #0 includes a PDCCH, which schedules SIB1 on a PDSCH, and SIB1 contains IE servingCellConfigCommon, which in turn contains IEs downlinkConfigCommon and uplinkConfigCommon, which in turn contain pairs of IEs initialDownlinkBWP and initialUplinkBWP respectively, one pair for an SSB time index. In another example, the CORESET #0 includes a PDCCH, and the PDCCH schedules SIB1, which contains multiple servingCellConfigCommon IEs, each containing a pair of IEs downlinkConfigCommon and uplinkConfigCommon, each in turn containing IEs initialDownlinkBWP and initialUplinkBWP. One servingCellConfigCommon IE corresponds to an SSB time index.

At action 920, the UE 115 may then act on the configuration information corresponding to its beam and ignore the configuration information that corresponds to other beams. Specifically, UE 115 may begin to use the initial uplink BWP an initial downlink the assigned to it via the SIB1. Other UEs on different beams would get different initial downlink BWPs and initial uplink BWPs. In other words, the initial downlink BWPs and initial uplink BWPs are beam-specific.

At action 880, the UE performs RACH access over its initial DL BWPs and the initial UL BWPs configured above. The UE obtains its dedicated DL BWP and UL BWP for data transmission if they are different from the initial uplink BWP and the initial downlink BWP. Other UEs perform RACH access over their respective initial BWPs on their respective beams.

In some example systems, SIB1 is not the only SIB, as other SIBs (e.g., SIB 2-SIB11) may also exist, and actions 930, 935, 940 show different options for transmitting those other SIBs.

For instance, in one example, action 930 includes broadcasting the remaining SIBs in a common BWP. In such an instance, scheduling information on the remaining SIBs refer to the common BWP. In another example, action 935 includes the remaining SIBs of the beam being broadcast in the associated initial downlink BWP. Scheduling information on RACH occasions and remaining SIB s refer to the initial BWP pairs. In yet another example, the remaining SIB s of the beam are transmitted in the initial downlink the after RACH upon request from the UE 115. Scheduling information on the remaining SIB s may then refer to the initial BWP pairs. Of course, the scope of implementations is not limited to just these options, as, for instance, another example includes a mixture of the three options, where some SIBs are treated according to action 930, other SIBs are treated according to action 935, and yet other SIBs are treated according to action 940. Any appropriate technique to transmit SIBs from BS 105 to UE 115 may be used.

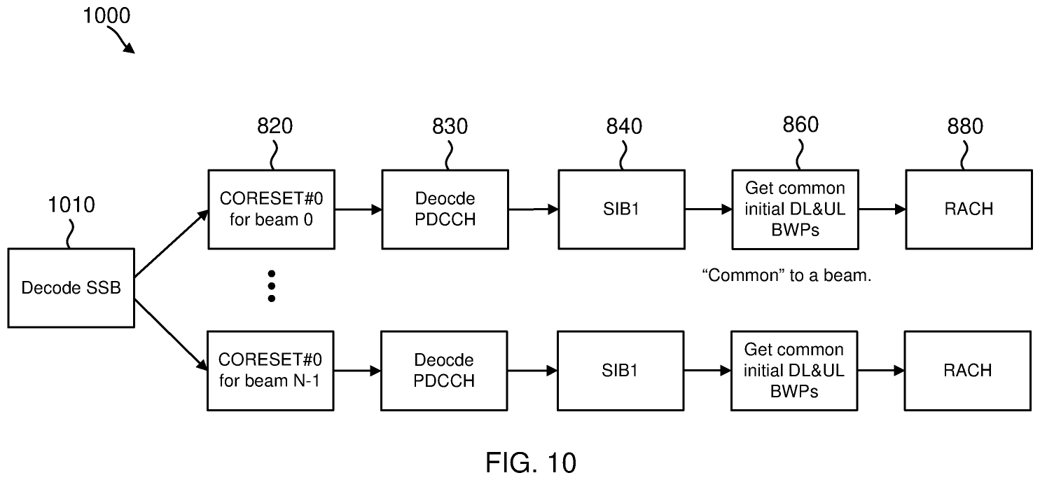

FIG. 10 illustrates example method 1000, which is similar to method 900 of FIG. 9, except in the example of method 1000, it is the SSB which has the beam-specific information and causes the initial access process to branch. In one example, each SSB carries a plurality of IE pairs of pdcch-configSIB1 and subCarrierSpacingCommon, which together point to N different CORESET #0s, where each pair corresponds to a beam.

At action 1010, the UE 115 decodes the SSB to acquire an MIB. In this example, the MIB identifies a first CORESET #0 which includes a PDCCH. The PDCCH schedules on a PDSCH for the transmission of a SIB1, which has configuration information specific to the beam on which UE 115 is operating. The MIB may also identify a second CORESET #0 having other configuration information specific to a different beam. UE 115 may parse the MIB using a time index corresponding to its beam to identify its corresponding CORESET #0. UE 115 may then use its identified CORESET #0 at action 820 and ignore other CORESET #0s. Other UEs on different beams may identify different corresponding CORESET #0s. As in method 900, the initial uplink and downlink BWPs are beam-specific. An advantage of the example method 1000 is that the SSB's are the same and they can be combined to enhance the performance of SSB decoding.

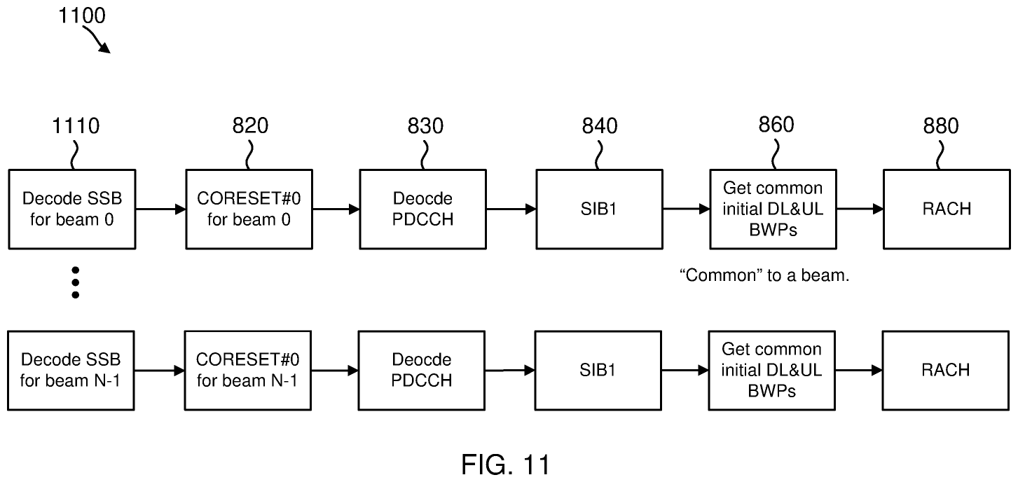

FIG. 11 illustrates example method 1100, which is similar to methods 900 of FIGS. 9 and 1000 of FIG. 10, except that in the example of method 1100, the SSBs are specific to individual beams. This is in contrast to method 1000, where the SSBs are common but identify beam-specific CORESET #0s. For instance, in one example method 1100, each SSB carries IEs pdcch-configSIB1 and subCarrierSpacingCommon, which together point to an individual CORESET #0, where different SSBs may point to different CORESET #0s. Each individual CORESET #0 schedules SIB1, which contains IE servingCellConfigCommon, which in turn contains IEs downlinkConfigCommon and uplinkConfigCommon, which in turn contain IEs initialDownlinkBWP and initialUplinkBWP respectively.

At action 1110, the UE decodes the SSB to acquire an MIB. In this example, the MIB identifies a first CORESET #0 having configuration information specific to the first beam but excludes configuration information specific to other beams. Other UEs on different beams receive and decode different SSBs, which point to different CORESET #0s. An advantage of the example method 1100 is that an SSB carries only the information relevant to the UE that is able to decode the SSB.

Of course, each method 1000, 1100 includes that the UE 115 performs RACH over its initial downlink BWP and its initial uplink so that the base station 105 may allocate a dedicated uplink and downlink BWP for data transmission.

The scope of implementations is not limited to the specific methods shown in FIGS. 8-11. Instead, other implementations may add, omit, rearrange, or modify ones of the actions. For example, some implementations may include performing any one of methods 800, 900, 1000, or 1100 for beam handover.

As noted above, various implementations may include advantages not provided by current techniques. Specifically, various implementations may be applied to resources that may not be amenable to beam steering to provide reliable allocation of beams and BWPs to UEs. The reliable allocation of beams and BWPs to UEs may allow such resources to minimize or avoid instances of cell handover when beam handover is appropriate. Performing beam handover rather than cell handover may save overhead for resources that provide beams.

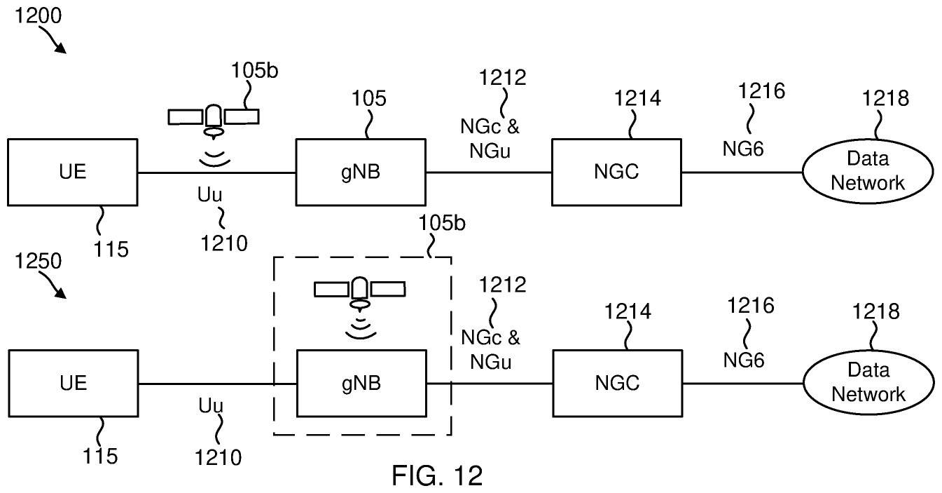

Examples of resources that provide beams include both terrestrial and NTN resources. Specifically, the principles described herein may be applied to terrestrial and NTN resources for those resources to allocate beams and BWPs to UEs. In some instances, a terrestrial or NTN resource may act as a base station, such as shown in FIG. 12 at communication system 1250. In FIG. 12, the data network 1218 communicates with the next generation core (NGC) 1214 via next generation 6 (NG6) interface 1216. The NGC 1214 and BS (shown as gNB) 105b communicate via a NG-1U interface (NGu, between 5G-radio Access Network and 5G User Plane) and a NG-1C interface (NGc, between 5G-Radio Access Network and 5G Core Control). Uu interface 1210 in this example is an air interface between 5G UE 115 and the 5G Radio Access Network (RAN). In other instances, a terrestrial or NTN resource may act as a reflector for a base station, such as shown in FIG. 12 at system 1200.

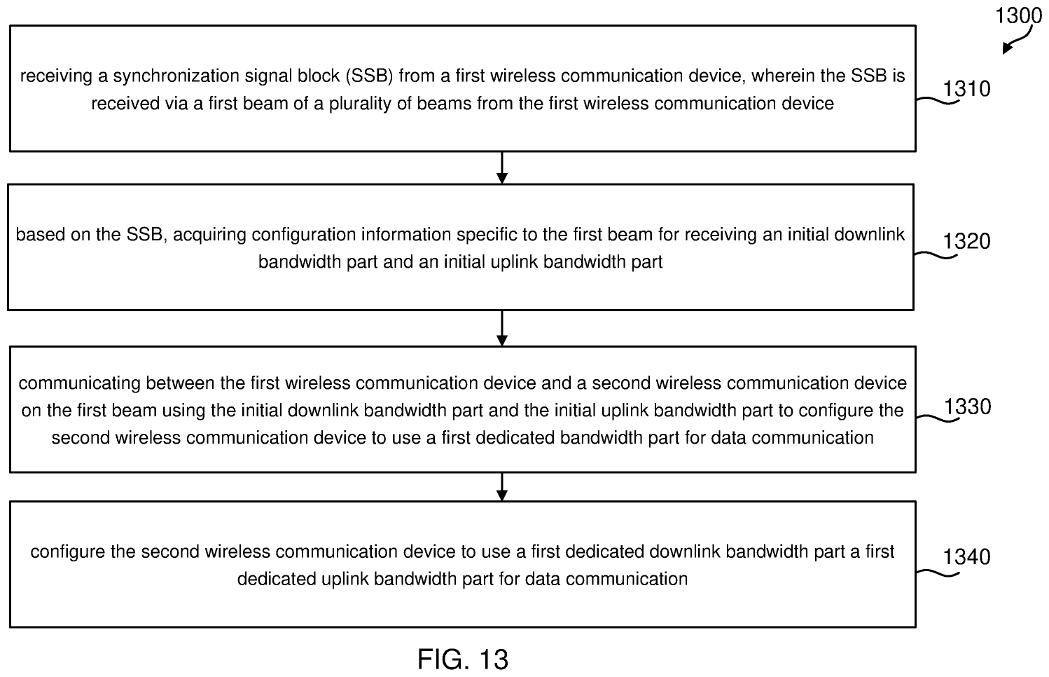

FIG. 13 is a flow diagram of a communication method 1300 according to some aspects of the present disclosure. Actions of the method 1300 can be executed by a computing device (e.g., a processor, processing circuit, and/or other suitable component) of an apparatus or other suitable means for performing the steps. For example, a UE, such as the UEs 115 and/or the UE 600, may utilize one or more components, such as the processor 602, the memory 604, the beam module 608, the transceiver 610, and the one or more antennas 616, to execute the steps of method 1300.

The method 1300 may employ similar mechanisms as in the methods 800-1100 described above with respect to FIGS. 8-11, respectively. As illustrated, the method 1300 includes a number of enumerated actions, but aspects of the method 1300 may include additional steps before, after, and in between the enumerated actions. In some aspects, one or more of the enumerated actions may be omitted or performed in a different order.

At block 1310, a UE receives an SSB from a first wireless communication device. In one example, the first wireless communication device includes a terrestrial base station, a satellite, or the like, such as base stations 105 or 700. For the purposes of the example of FIG. 13, the UE is referred to as a second wireless communication device.

Continuing with the example, the SSB is received via a first beam of a plurality of beams from the first wireless communication device. An example is shown at FIGS. 3 and 4, where the SSBs are transmitted sequentially one per-beam, and the BS provides a plurality of beams so that the first beam is one of multiple beams.

At block 1320, the second wireless communication device acquires configuration information specific for the first beam based on the SSB. The configuration information may be for receiving an initial downlink BWP and an initial uplink BWP. Of course, when the second wireless communication device receives the initial downlink BWP and the initial uplink BWP, it receives information (e.g., parameters found in SIB1) that enables it to find and use the initial downlink BWP and the initial uplink BWP. Thus, in some examples, block 1320 includes acquiring configuration information specific to the first beam for using an initial downlink bandwidth part and an initial uplink bandwidth part.

Examples of actions at block 1320 are shown at FIGS. 9-11. For instance, at method 900 of FIG. 9, the initial access process branches at the SIB1. Thus, the SIB1 is common across the multiple beams and includes information that is specific to each individual beam. The UE may parse the SIB1 using, e.g., a time index for its beam as a key, to identify configuration information specific to the beam. The UE may then use that configuration information to receive an initial uplink BWP and an initial downlink BWP.

In the example of method 1000 of FIG. 10, the initial access process branches at the SSB. Specifically, in that example, the SSB is common across the multiple beams, and it includes information that allows the UE to acquire a control resource set specific to its beam. The UE then uses the control resource set to identify a SIB1 that is specific to the beam and to receive an initial uplink BWP and an initial downlink BWP.

Looking at the example of method 1100 of FIG. 11, the initial access process branches before the SSB. In other words, each SSB is beam-specific. The UE receives the SSB on its beam, which allows the UE to access the core resource set, further allowing the UE to receive the initial uplink BWP and initial downlink BWP.

At block 1330, the first wireless communication device communicates with the second wireless communication device using the first beam and using the initial uplink BWP and the initial downlink BWP. Once the initial BWP parts are known, the first wireless communication device (BS) may perform any one or more of the following actions to configuring new BWPs for the second wireless communication device (UE): (a) Do nothing, so that the UE continues to use the initial uplink and downlink BWPs, (b) Configure a new uplink BWP and a new downlink BWP for the UE and other UEs in the same beam, in other words, a group/beam-based configuration, (c) Configure a new uplink BWP and a new downlink BWP for each of the UEs in the same beam, in other words, a UE-specific configuration. Each of the new uplink BWPs and downlink BWPs may be (or may be a part of) the new uplink and downlink BWPs in (b).

In an example 1340, the communication is for negotiating between the UE and the BS so that the BS may allocate a dedicated uplink BWP and a dedicated downlink BWP for data communication. An example set of beams and BWPs is shown at FIG. 3, though the scope of implementations may include any arrangement of beams and BWPs and any number of beams and BWPs. An example of communications between the UE and the BS for negotiating a BWP may include RACH access over PRACH.

Method 1300 may continue, e.g., by including data transmission by the UE and BS using the allocated and dedicated BWP.

Also, the scope of implementations is not limited to action performed by a UE, as methods within the scope of implementations may include actions performed by the BS. In one example, the BS sends the SSB to the UE on the first beam. Once the UE acquires configuration information specific to the first beam, the BS communicates with the UE using the first beam and the initial downlink BWP and the initial uplink. The BS then negotiates with the UE to allocate a dedicated BWP for data communication.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular implementations illustrated and described herein, as they are merely by way of some examples thereof, but rather, should be fully commensurate with that of the claims appended hereafter and their functional equivalents.

1. A method of wireless communication, the method comprising:
receiving a synchronization signal block (SSB) from a first wireless communication device;
acquiring information from the SSB, wherein the information from the SSB leads to configuration information for using an initial downlink bandwidth part and an initial uplink bandwidth part; and
communicating between the first wireless communication device and a second wireless communication device using the initial downlink bandwidth part and the initial uplink bandwidth part.

2. The method of wireless communication of claim 1, wherein the SSB uses a common frequency range contained in the initial downlink bandwidth part.

3. The method of wireless communication of claim 1, wherein the SSB uses a common frequency range not contained in any initial downlink bandwidth part used by the first wireless communication device.

4. The method of wireless communication of claim 1, wherein the SSB uses a common frequency range partially contained in the initial downlink bandwidth part and partially contained in an additional downlink bandwidth part.

5. The method of wireless communication of claim 1, wherein acquiring the configuration information comprises:
receiving a first system information block (SIB) from the first wireless communication device, wherein the first SIB comprises the configuration information which is specific to a first beam in addition to other configuration information specific to a second beam.

6. The method of wireless communication of claim 5, further comprising:
receiving a second SIB on a common frequency used by the SSB.

7. The method of wireless communication of claim 5, further comprising:
receiving a second SIB on the initial downlink bandwidth part.

8. The method of wireless communication of claim 5, further comprising:
receiving a second SIB in response to a random-access channel (RACH) request on the initial downlink bandwidth part.

9. The method of wireless communication of claim 1, wherein acquiring the configuration information comprises:
decoding the SSB to acquire a master information block (MIB),
wherein the MIB identifies a first control resource set comprising a first Physical Downlink Control Channel (PDCCH), and wherein the first PDCCH schedules on a first Physical Downlink Shared Channel (PDSCH) comprising a first system information block (SIB) specific to a first beam in addition to identifying a second control resource set comprising a second Physical Downlink Control Channel (PDCCH), and the second PDCCH schedules on a second Physical Downlink Shared Channel (PDSCH) comprising a second SIB specific to a second beam.

10. The method of wireless communication of claim 9, wherein the SSB is common to both the first beam and the second beam.

11. The method of wireless communication of claim 1, wherein acquiring the configuration information comprises:
decoding the SSB to acquire a master information block (MIB), wherein the MIB identifies a first control resource set comprising a Physical Downlink Control Channel (PDCCH), and the PDCCH schedules on a Physical Downlink Shared Channel (PDSCH) comprising a SIB, and the SIB comprises the configuration information which is specific to a first beam and excludes other configuration information specific to a second beam.

12. The method of wireless communication of claim 1, wherein communicating between the first wireless communication device and the second wireless communication device comprises:
negotiating use of a first dedicated bandwidth part by a random-access channel (RACH) via the initial downlink bandwidth part and the initial uplink bandwidth part.

13. The method of wireless communication of claim 1, wherein the first wireless communication device comprises a non-terrestrial network element.

14. The method of wireless communication of claim 1, wherein the second wireless communication device comprises a user equipment (UE).

15. The method of wireless communication of claim 1, wherein the communicating comprises receiving first information from the first wireless communication device using the initial downlink bandwidth part and transmitting second information to the first wireless communication device using the initial uplink bandwidth part.

16. An apparatus comprising:
a transceiver configured to:
receive a synchronization signal block (SSB) from a first wireless communication device; and
a processor configured to:
acquire information from the SSB which leads to configuration information for using an initial downlink bandwidth part and an initial uplink bandwidth part; and
negotiate with the first wireless communication device using the initial downlink bandwidth part and the initial uplink bandwidth part.

17. The apparatus of claim 16, wherein the transceiver and the processor are included in a user equipment (UE).

18. The apparatus of claim 16, wherein receiving the SSB comprises communicating with a non-terrestrial network resource.

19. A non-transitory computer-readable medium having program code recorded thereon, the program code comprising:
code for receiving a synchronization signal block (SSB) from a first wireless communication device;
code for acquiring information from the SSB which leads to configuration information for using an initial downlink bandwidth part and an initial uplink bandwidth part; and
code for negotiating with the first wireless communication device using the initial downlink bandwidth part and the initial uplink bandwidth part.

20. The non-transitory computer-readable medium of claim 19, wherein the SSB uses a common frequency range contained in the initial downlink bandwidth part.

21. The non-transitory computer-readable medium of claim 19, wherein the SSB uses a common frequency range not contained in any initial downlink bandwidth parts used by the first wireless communication device.

22. The non-transitory computer-readable medium of claim 19, wherein the SSB uses a common frequency range partially contained in the initial downlink bandwidth part and partially contained in an additional downlink bandwidth part.

23. The non-transitory computer-readable medium of claim 19, wherein the code to acquire the configuration information comprises:
code to receive a first system information block (SIB) from the first wireless communication device, wherein the first SIB comprises the configuration information which is specific to a first beam in addition to other configuration information specific to a second beam.

24. The non-transitory computer-readable medium of claim 19, wherein the code to acquire the configuration information comprises:
code to decode the SSB to acquire a master information block (MIB),
wherein the MIB identifies a first control resource set comprising a first Physical Downlink Control Channel (PDCCH), and the first PDCCH schedules on a first Physical Downlink Shared Channel (PDSCH) comprising a first system information block (SIB) specific to a first beam in addition to identifying a second control resource set comprising a second Physical Downlink Control Channel (PDCCH), and the second PDCCH schedules on a second Physical Downlink Shared Channel (PDSCH) comprising a second SIB specific to a second beam.

25. An apparatus comprising:
means for receiving a synchronization signal block (SSB) from a first wireless communication device;
means for acquiring information from the SSB which leads to configuration information for using an initial downlink bandwidth part and an initial uplink bandwidth part; and
means for communicating between the first wireless communication device and a second wireless communication device using the initial downlink bandwidth part and the initial uplink bandwidth part.

26. The apparatus of claim 25, comprising a user equipment (UE).

27. A method of wireless communication, the method comprising:
transmitting a synchronization signal block (SSB) from a first wireless communication device, wherein information in the SSB leads to configuration information for using an initial downlink bandwidth part and an initial uplink bandwidth part; and
communicating between the first wireless communication device and a second wireless communication device using the initial downlink bandwidth part and the initial uplink bandwidth part.

28. The method of wireless communication of claim 27, wherein the first wireless communication device comprises a base station.

29. The method of wireless communication of claim 27, wherein the first wireless communication device comprises a non-terrestrial network resource.

30. The method of wireless communication of claim 27, further comprising:
transmitting a first system information block (SIB) from the first wireless communication device, wherein the first SIB comprises the configuration information which is specific to a first beam in addition to other configuration information specific to a second beam.

31. The method of wireless communication of claim 27, wherein the information in the SSB comprises a master information block (MIB), wherein the MIB identifies a first control resource set comprising a first Physical Downlink Control Channel (PDCCH), and the first PDCCH schedules on a first Physical Downlink Shared Channel (PDSCH) comprising a first system information block (SIB) which is specific to a first beam in addition to identifying a second control resource set comprising a second Physical Downlink Control Channel (PDCCH), and the second PDCCH schedules on a second Physical Downlink Shared Channel (PDSCH) comprising a second SIB specific to a second beam.

32. The method of wireless communication of claim 27, wherein the information in the SSB comprises a master information block (MIB), wherein the MIB identifies a first control resource set comprising a Physical Downlink Control Channel (PDCCH), and the PDCCH schedules on a Physical Downlink Shared Channel (PDSCH) comprising a SIB, and the SIB comprises the configuration information which is specific to a first beam and excludes other configuration information specific to a second beam.

33. The method of wireless communication of claim 27, wherein communicating between the first wireless communication device and the second wireless communication device comprises:
negotiating use of a first dedicated bandwidth part by a random-access channel (RACH) via the initial downlink bandwidth part and the initial uplink bandwidth part.

34. An apparatus comprising:
a transceiver configured to:
transmit a synchronization signal block (SSB) from a first wireless communication device, wherein information in the SSB leads to configuration information for using an initial downlink bandwidth part and an initial uplink bandwidth part; and
a processor configured to:
communicate between the first wireless communication device and a second wireless communication device using the initial downlink bandwidth part and the initial uplink bandwidth part.

35. The apparatus of claim 34, wherein the transceiver and the processor are included in a base station.

36. The apparatus of claim 34, wherein the transceiver is configured to communicate with a user equipment (UE).

37. An apparatus comprising:
means for transmitting a synchronization signal block (SSB) from a first wireless communication device, wherein information in the SSB leads to configuration information for using an initial downlink bandwidth part and an initial uplink bandwidth part; and
means for communicating between the first wireless communication device and a second wireless communication device using the initial downlink bandwidth part and the initial uplink bandwidth part.

38. The apparatus of claim 37, comprising a base station.
